(19) United States
(12) Patent Application Publication
(10) Pub. No.: US 2016/0036475 A1
(43) Pub. Date: Feb. 4, 2016

(54) Portable Wireless Network Assembly

(71) Applicant: Christopher Nunez, Queens, NY (US)

(72) Inventor: Christopher Nunez, Queens, NY (US)

(21) Appl. No.: 14/449,579

(22) Filed: Aug. 1, 2014

(51) Int. Cl. H04B 1/3827; H04B 7/26; H04B 7/14

(52) U.S. Cl. CPC H04B 1/385; H04B 7/14; H04B 7/26; H04W 84/005

(57) ABSTRACT

A portable wireless network assembly includes a band that may be worn by a user. A processor is coupled to the band. A transceiver is coupled to the band. The transceiver is operationally coupled to the processor. The transceiver is in communication with an external signal source and an external electronic device. The transceiver relays a signal from the external signal source to the external electronic device. A display is coupled to the band. The display is operationally coupled to the processor. The display displays operational data relating to the transceiver.

### BACKGROUND OF THE DISCLOSURE

### Field of the Disclosure

The disclosure relates to wireless network devices and more particularly pertains to a new wireless network device for coupling an external electronic device to the internet via a cellular phone network.

### SUMMARY OF THE DISCLOSURE

An embodiment of the disclosure meets the needs presented above by generally comprising a band that may be worn by a user. A processor is coupled to the band. A transceiver is coupled to the band. The transceiver is operationally coupled to the processor. The transceiver is in communication with an external signal source and an external electronic device. The transceiver relays a signal from the external signal source to the external electronic device. A display is coupled to the band. The display is operationally coupled to the processor. The display displays operational data relating to the transceiver.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a portable wireless network assembly according to an embodiment of the disclosure.

FIG. 2 is a top view of an embodiment of the disclosure.

FIG. 3 is a front view of an embodiment of the disclosure.

FIG. 4 is a bottom view of an embodiment of the disclosure.

FIG. 5 is a schematic view of an embodiment of the disclosure.

### DESCRIPTION OF THE PREFERRED EMBODIMENT

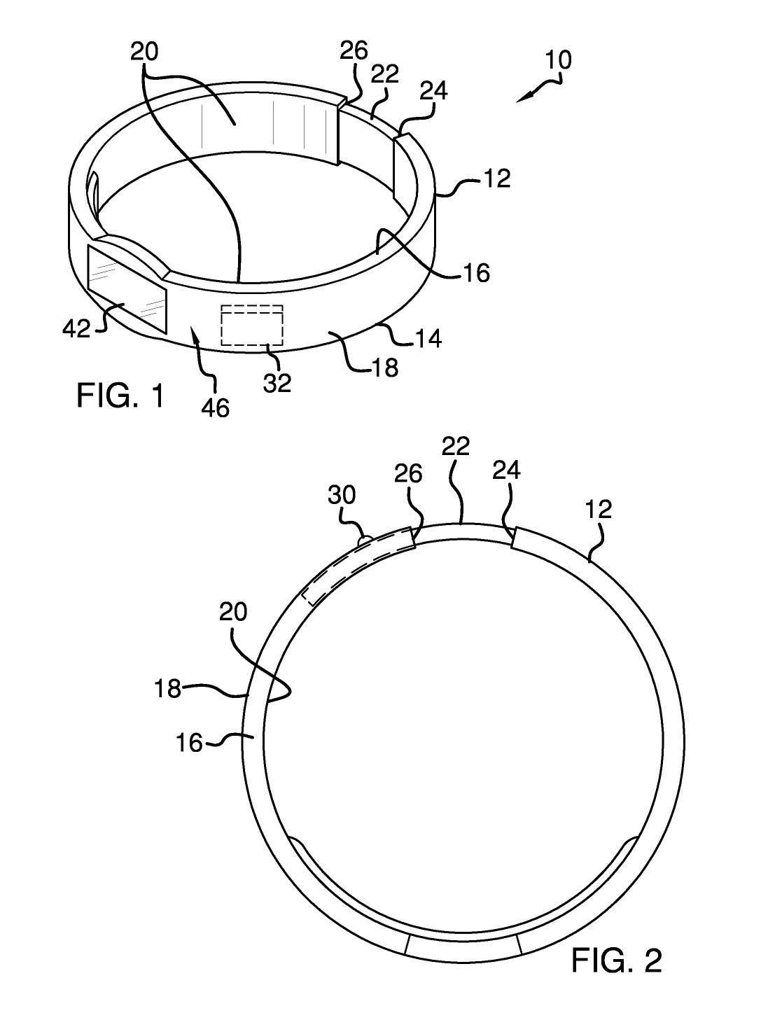

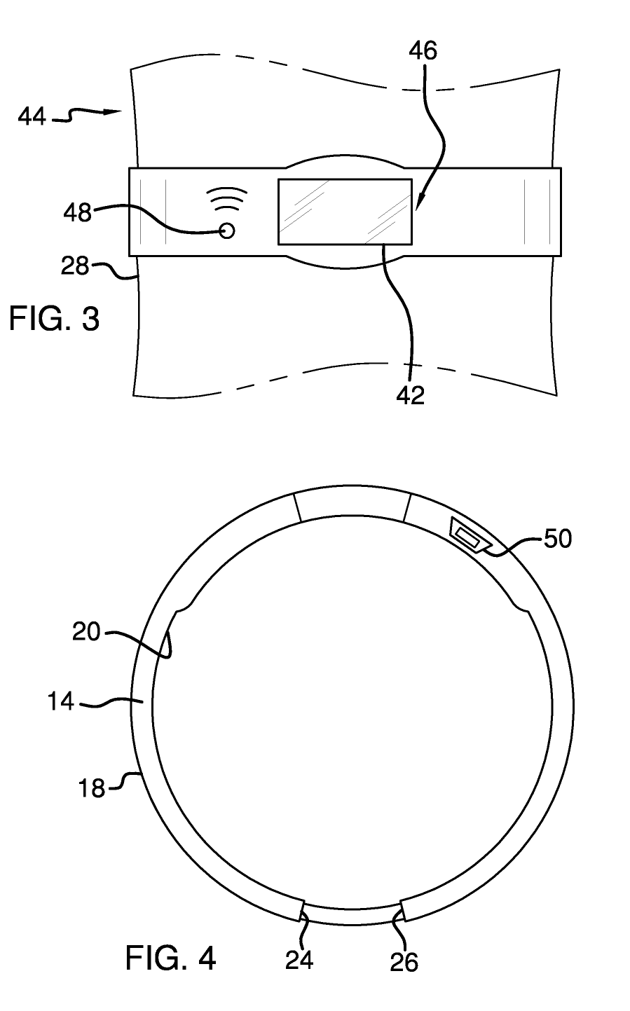

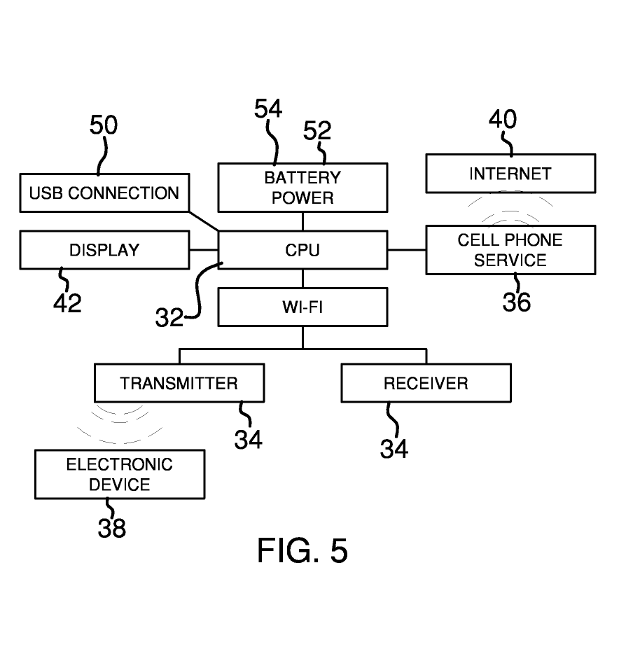

With reference now to the drawings, and in particular to FIGS. 1 through 5 thereof, a new wireless network device embodying the principles and concepts of an embodiment of the disclosure and generally designated by the reference numeral 10 will be described.

As best illustrated in FIGS. 1 through 5, the portable wireless network assembly 10 generally comprises a band 12. The band 12 has a first lateral edge 14 and a second lateral edge 16 each extending between a top side 18 and a bottom side 20 of the band 12. A coupler 22 is coupled to a first end 24 of the band 12. The coupler 22 removably engages a second end 26 of the band 12 so the band 12 forms a closed loop. The band 12 may be worn around a user's wrist 28. Moreover, the coupler 22 retains the band 12 on the user's wrist 28.

A lock 30 is movably coupled to the top side 18 of the band 12. The lock 30 is positioned proximate the second end 26 of the band 12. The lock 30 engages the coupler 22. Additionally, the lock 30 may be depressed so the coupler 22 is released from the second end 26 of the band 12.

A processor 32 is coupled to the band 12. The processor 32 may be an electronic processor of any conventional design. A transceiver 34 is coupled to the band 12. Additionally, the transceiver 34 is electrically coupled to the processor 32.

The transceiver 34 is in electromagnetic communication with an external signal source 36 and an external electronic device 38. The transceiver 34 relays a signal from the external signal source 36 to the external electronic device 38. The external signal source 36 may be a cellular phone network. Moreover, the external electronic device 38 may be a personal computer of any conventional design intended to be placed in communication with the internet 40.

The transceiver 34 may be an RF transceiver of any conventional design. The transceiver 34 may transmit a WLAN signal. The WLAN signal may utilize 802.11 a/b/g/n signal protocols. Moreover, the transceiver 34 establishes a wireless internet connection to be utilized by the external electronic device 38.

A display 42 is coupled to the top side 18 of the band 12 so the display 42 is visible to the user 44. The display 42 is electrically coupled to the processor 32. Additionally, the display 42 displays operational data relating to the transceiver 34. The display 42 may be a touch screen display of any conventional design. The first 14 and second 16 lateral edges of the band 12 each curve outwardly from a center 46 of the band 12 proximate the display 42.

A light emitter 48 is coupled to the top side 18 of the band 12. The light emitter 48 is electrically coupled to the processor 32. Additionally, the light emitter 48 emits light when the transceiver 34 is placed in electromagnetic communication with the external signal source 36. The light emitter 48 may be an LED of any conventional design.

A data port 50 is coupled to the first lateral edge 14 of the band 12. The data port 50 is electrically coupled to the processor 32. Additionally, the data port 50 may be a USB port of any conventional design. The data port 50 may be selectively electrically coupled to the external electronic device 38.

A power supply 52 is coupled to the band. The power supply 52 is electrically coupled to the processor 32. The power supply 52 comprises at least one battery 54.

In use, the user 44 touches the display 42 to connect the transceiver 34 to the external signal source 36. The external electronic device 38 is placed in communication with the transceiver 34 after the transceiver 34 is placed in communication with the external signal source 36. The assembly 10 provides a wireless internet connection wherever a cellular phone network signal is available.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A portable wireless network assembly comprising:
a band configured to be worn by a user;
a processor coupled to said band;
a transceiver coupled to said band, said transceiver being operationally coupled to said processor, said transceiver being in communication with an external signal source and an external electronic device such that said transceiver relays a signal from the external signal source to the external electronic device; and
a display coupled to said band, said display being operationally coupled to said processor such that said display displays operational data relating to said transceiver.

2. The portable wireless network assembly according to claim 1, further comprising said transceiver being electrically coupled to said processor, said transceiver being in electromagnetic communication between the external signal source and the external electronic device.

3. The portable wireless network assembly according to claim 1, further comprising said band having a top side and a bottom side, said display being coupled to said top side of said band such that said display is visible to the user.

4. The portable wireless network assembly according to claim 3, further comprising said display being electrically coupled to said processor.

5. The portable wireless network assembly according to claim 1, further comprising said band having a first lateral edge and a second lateral edge each extending between a top side and a bottom side of said band, a data port coupled to said first lateral edge of said band.

6. The portable wireless network assembly according to claim 5, further comprising said data port being electrically coupled to said processor.

7. The portable wireless network assembly according to claim 1, further comprising a power supply coupled to said band.

8. The portable wireless network assembly according to claim 7, further comprising said power supply being electrically coupled to said processor.

9. The portable wireless network assembly according to claim 8, where comprising said power supply comprising at least one battery.

10. A portable wireless network assembly comprising:
a band having a first lateral edge and a second lateral edge each extending between a top side and a bottom side of said band such that said band is configured to be worn by a user;
a processor coupled to said band;
a transceiver coupled to said band, said transceiver being electrically coupled to said processor, said transceiver being in electromagnetic communication with an external signal source and an external electronic device such that said transceiver relays a signal from the external signal source to the external electronic device;
a display coupled to said top side of said band such that said display is visible to the user, said display being electrically coupled to said processor such that said display displays operational data relating to said transceiver;
a data port coupled to said first lateral edge of said band, said data port being electrically coupled to said processor; and
a power supply coupled to said band, said power supply being electrically coupled to said processor, said power supply comprising at least one battery.
